(19) United States
(12) Patent Application Publication
(10) Pub. No.: US 2015/0107542 A1
(43) Pub. Date: Apr. 23, 2015

(54) ENGINE

(71) Applicant: FUJI JUKOGYO KABUSHIKI KAISHA, TOKYO (JP)

(72) Inventors: Yasuaki KYOKANE, Tokyo (JP); Masanori NOGUCHI, Tokyo (JP)

(21) Appl. No.: 14/516,465

(22) Filed: Oct. 16, 2014

(30) Foreign Application Priority Data
Oct. 22, 2013 (JP) 2013-219266

(51) Int. Cl. F02N 3/02; F02N 19/00; F02N 15/02

(52) U.S. Cl. CPC F02N 3/02; F02N 15/022; F02N 19/001
USPC 123/179.28

(57) ABSTRACT

An engine having a crank shaft which is caused to start to rotate by pulling a recoil rope includes: a reel around which the recoil rope is wound; a clutch mechanism which is provided between the reel and the crank shaft and switchable between a first state and a second state; and a sub-generator connected to the reel. The first state of the clutch mechanism allows transmission of force in one direction from the reel to the crank shaft, while the second state does not allow transmission of force in both directions between the reel and the crank shaft. When the crank shaft is caused to start to rotate, the clutch mechanism is switched to the first state, whereas when the sub-generator is driven for power generation, the clutch mechanism is switched to the second state.

### CROSS-REFERENCE TO RELATED APPLICATIONS

The present disclosure claims priority from Japanese Patent Application No. 2013-219266 filed on Oct. 22, 2013, the entire contents of which are hereby incorporated by reference.

### BACKGROUND

1. Technical Field

The present disclosure relates to an engine including a crank shaft which is caused to start to rotate by pulling a recoil rope.

2. Related Art

A general purpose type engine (hereinafter referred to as a general purpose engine) is used as a power source for a machine such as a construction machine and a farm machine in small size. Many of such general purpose engines are provided with a recoil starter as an engine starting mechanism. The recoil starter includes a reel connected to a crank shaft, and a recoil rope which is wound around the reel. When an engine is caused to start, the recoil rope is pulled to rotate the reel then the crank shaft is caused to start to rotate.

In recent years, a fuel injection system and an electronic governor system have been adopted for a general purpose engine. A general purpose engine including an electronic control system such as a fuel injection system has an increased electric power consumption at the time of engine operation, and thus typically includes a power generator that is operated in coordination with the crank shaft (see Japanese Unexamined Patent Application Publication No. 2004-316451).

In a general purpose engine including a fuel injection system, a fuel pump or the like needs to be driven at the time of engine start, and thus sufficient electric power supply is needed in order to favorably start the engine. However, in a general purpose engine which is caused to start by a recoil starter, it has been difficult to maintain high starting rotation of the crank shaft and to obtain sufficient electric power from the power generator.

For this reason, when a general purpose engine including a fuel injection system is caused to start, it has been needed to start to rotate the crank shaft over and over again and to drive the power generator until power needed for initial operation of the fuel injection system is reliably stored. That is, an operation of the recoil starter is needed over and over again at the time of engine start, and thus it is demanded that the starting performance of the engine be improved.

### SUMMARY OF THE INVENTION

The present disclosure has been designed in consideration of the circumstances described above, and an object thereof is to provide an engine having an improved starting performance.

An aspect of the present disclosure provides an engine having a crank shaft which is caused to start to rotate by pulling a recoil rope, the engine including: a reel around which the recoil rope is wound; a clutch mechanism which is provided between the reel and the crank shaft and switchable between a first state and a second state; and a power generator connected to the reel. The first state of the clutch mechanism allows transmission of force in one direction from the reel to the crank shaft, while the second state does not allow transmission of force in both directions between the reel and the crank shaft. When the crank shaft is caused to start to rotate, the clutch mechanism is switched to the first state, whereas when the power generator is driven for power generation, the clutch mechanism is switched to the second state.

### BRIEF DESCRIPTION OF THE DRAWINGS

FIG. 1 is a partial cross-sectional view illustrating the internal structure of an engine according to an implementation of the present disclosure;

FIG. 2 is an enlarged partial cross-sectional view illustrating part of the engine;

FIGS. 3A and 3B are explanatory diagrams illustrating a swinging process of ratchet pawls;

FIGS. 4A to 4D are explanatory diagrams illustrating the operation process of a clutch mechanism in a starting mode;

FIGS. 5A and 5B are explanatory diagrams illustrating the operation of the ratchet pawls in a power generation mode;

FIGS. 6A to 6D are explanatory diagrams illustrating the operation process of the clutch mechanism in the power generation mode;

FIG. 7 is a block diagram schematically illustrating part of the electrical system of the engine;

FIG. 8 is a flow chart illustrating an exemplary procedure for starting the engine; and

FIG. 9 is a flow chart illustrating an exemplary procedure for starting the engine.

### DETAILED DESCRIPTION

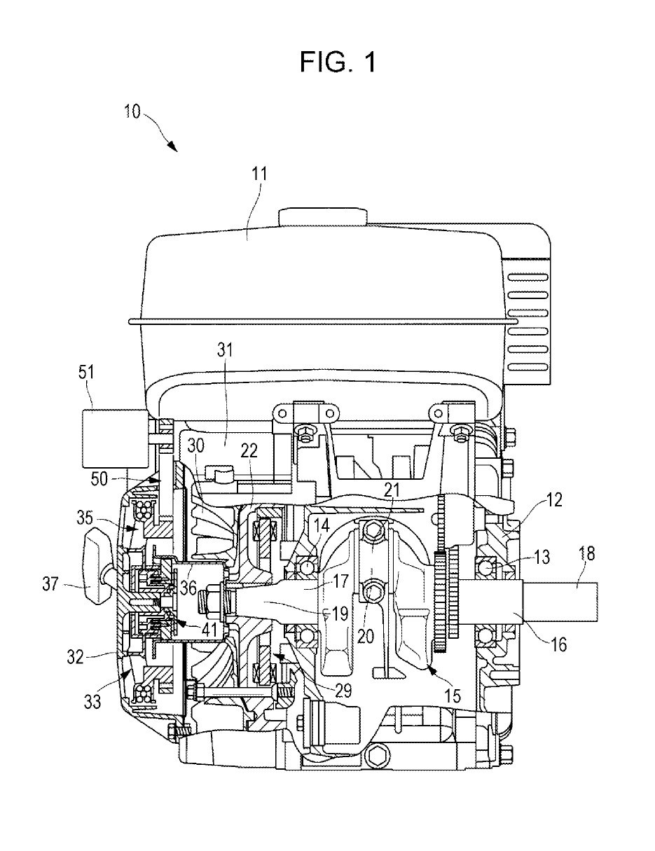

Hereinafter, an implementation of the present disclosure will be described in detail with reference to the drawings. As illustrated in FIG. 1, the engine 10 has a fuel tank 11 provided in the upper portion, and a crank case 12 provided in the lower portion. In the crank case 12, journals 16 and 17 of a crank shaft 15 are rotatably supported via bearings 13 and 14. The crank shaft 15 has an output shaft 18 which is connected to the journal 16. In addition, the crank shaft 15 has a taper shaft 19 which is connected to the journal 17. A connecting rod 21, which connects the crank shaft 15 and a piston (not illustrated), is attached to a crank pin 20 of the crank shaft 15.

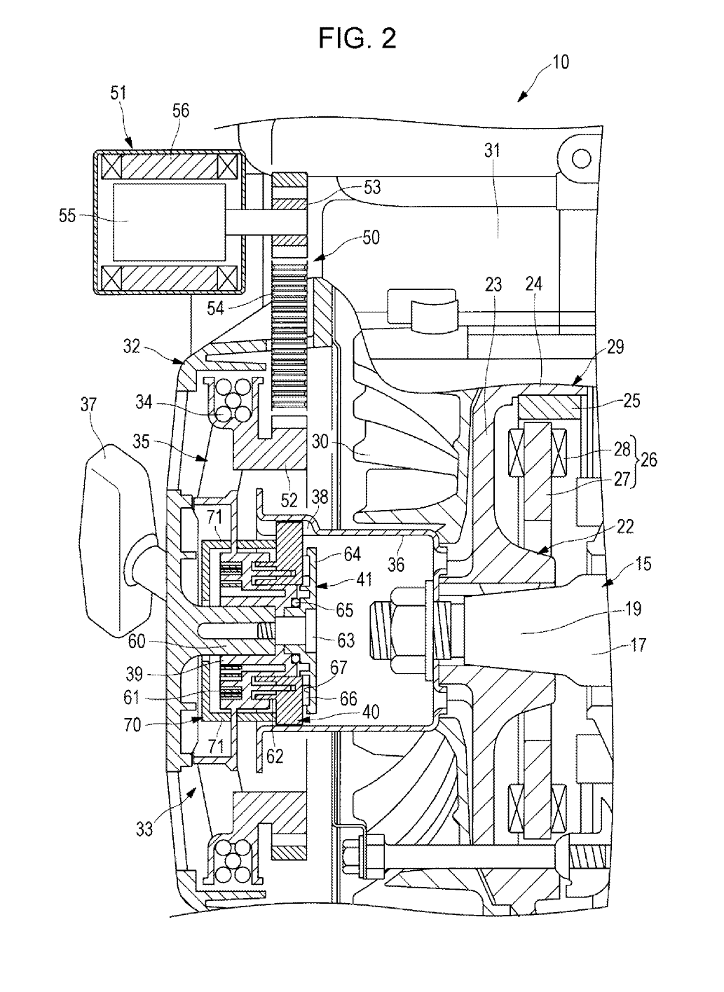

As illustrated in FIGS. 1 and 2, a flywheel 22 is connected to the taper shaft 19 of the crank shaft 15. The flywheel 22 includes a disc-shaped portion 23 fixed to the taper shaft 19 and a cylindrical portion 24 provided on the outer circumference of the disc-shaped portion 23. A permanent magnet 25 is fixed to the inner surface of the cylindrical portion 24, and a stator 26 is disposed radially inward of the cylindrical portion 24. The stator 26 includes a core 27 fixed to the crank case 12 and a coil 28 wound around the core 27. In this manner, the engine 10 is provided with a main generator 29 that includes the flywheel 22 and the stator 26. The amount of electric power generation of the main generator 29 increases or decreases in relation to the rotational speed of the crank shaft 15, that is, the rotational speed of the engine.

The disc-shaped portion 23 of the flywheel 22 is provided with a cooling fan 30, and the crank case 12 is provided with a fan housing 31 that surrounds the cooling fan 30. In addition, the fan housing 31 is provided with a starter cover (cover member) 32, and a recoil starter 33, which is a starting mechanism, is incorporated into the inside of the starter cover 32. The recoil starter 33 includes a reel 35 around which a recoil rope 34 is wound, and a cup 36 attached to the pointed end of the taper shaft 19. The end of the recoil rope 34 is provided with a recoil knob (handle member) 37 which is to be grasped by an operator. Also, the cup 36 includes a projection 38 that projects inwardly in a radial direction. The recoil starter 33 has ratchet pawls 40 which are pivotally provided on a boss 39 of the reel 35. As described later, when an operator pulls the recoil rope 34 to rotate the reel 35, each of the ratchet pawls 40 outwardly swings in coordination with the rotation of the reel 35, thereby making it possible to connect the reel 35 and the cup 36 by the ratchet pawls 40. That is, a clutch mechanism 41 including the cup 36 and the ratchet pawls 40 is incorporated in the recoil starter 33.

In addition, the reel 35 of the recoil starter 33 is connected to a sub-generator (power generator) 51 via a belt-type power transmission mechanism 50. The power transmission mechanism 50 has a driving pulley (first rotating body) 52 provided in the reel 35, a driven pulley (second rotating body) 53 provided in the sub-generator 51, and a belt 54 which is wound around the driving pulley 52 and the driven pulley 53. The driving pulley 52 is formed to have a greater diameter than the driven pulley 53 has. That is, the driving pulley 52 is formed to have a greater number of teeth than the driven pulley 53 has. As illustrated in FIG. 2, the sub-generator 51 includes a rotor 55 connected to the driven pulley 53, and a stator 56 which is disposed radially outward of the rotor 55. The sub-generator 51 is driven for power generation in coordination with an operation of the recoil starter 33.

Next, the clutch mechanism 41 of the recoil starter 33 will be described in detail. As illustrated in FIG. 2, the boss 39 of the reel 35 is rotatably attached to a post portion 60 which is formed in the center of the starter cover 32. A spring (spring member) 61, which is also called a spiral spring, is attached between the starter cover 32 and the reel 35. The spring 61 urges the reel 35 in a rotation direction in which the recoil rope 34 is wound. That is, when the reel 35 is rotated in a direction in which the recoil rope 34 is pulled out, the spring 61 is compressed, whereas when the reel 35 is rotated in a direction in which the recoil rope 34 is wound, the compression of the spring 61 is released. Also, the boss 39 of the reel 35 is provided with a pair of the ratchet pawls 40 which are pivotally supported on a shaft 62 as a center. Also, a support screw 63 is attached to the post portion 60 of the starter cover 32, and a guide plate 64 is rotatably supported on the support screw 63. A friction spring 65 is attached to the guide plate 64, and the boss 39 of the reel 35 and the guide plate 64 are in contact with each other via the friction spring 65. Furthermore, the guide plate 64 is provided with a guide groove 67 in which protrusions 66 of the ratchet pawls 40 are housed.

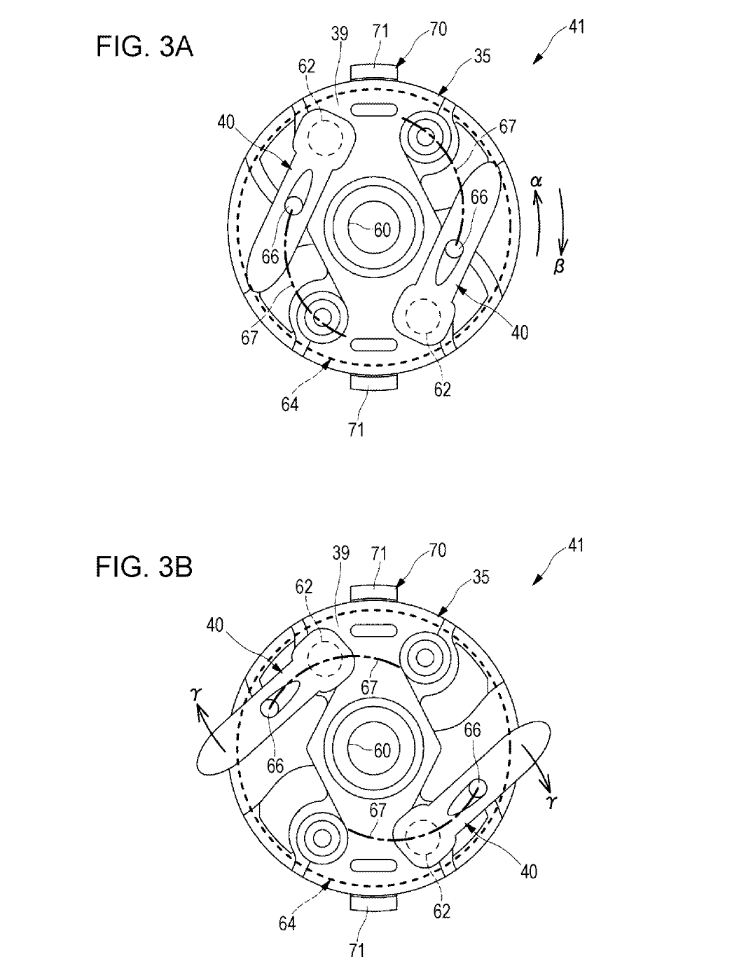

Next, the swinging operation of the ratchet pawls 40 will be described. FIGS. 3A and 3B are explanatory diagrams illustrating the swinging process of the ratchet pawls 40. FIGS. 3A and 3B illustrate the clutch mechanism 41 with the guide plate 64 and the support screw 63 removed. It is to be noted that the outline of the guide plate 64 is indicated by a dashed line and a center line of the guide groove 67 of the guide plate 64 is indicated by an alternate long and short dashed line in FIGS. 3A and 3B.

As described above, the reel 35 and the guide plate 64 are in contact with each other via the friction spring 65. For this reason, when an operator pulls the recoil rope 34 to rotate the reel 35 forcefully, sliding occurs between the reel 35 and the guide plate 64, then the guide plate 64 starts to rotate later than the reel 35. That is, as illustrated in FIG. 3A, when the recoil rope 34 is pulled to rotate the reel 35 in the direction of arrow α, the guide plate 64 rotates relative to the reel 35 in the direction of arrow β. In this manner, when the guide plate 64 rotates relative to the reel 35, the protrusion 66 of each ratchet pawl 40 moves radially outward along the guide groove 67, and the ratchet pawl 40 swings so that the pointed end thereof moves radially outward. That is, as illustrated in FIG. 3B, the ratchet pawl 40 swings in the direction of arrow γ around a fulcrum of the shaft 62.

As illustrated in FIG. 2, the clutch mechanism 41 has a lock member 70 which is rotatably attached to the boss 39 of the reel 35. As illustrated in FIGS. 2 and 3, the lock member 70 includes a pair of lock pieces 71 that extend along the outer circumferential surface of the boss 39. The clutch mechanism 41 may be switched between a starting mode (first state) and a power generation mode (second state) by changing the position of the lock member 70. When the clutch mechanism 41 is switched to the starting mode, the lock member 70 is placed at a release position illustrated in FIGS. 3A and 3B. As illustrated in FIGS. 3A and 3B, the release position of the lock member 70 does not cause the lock member 70 to interfere with the ratchet pawls 40.

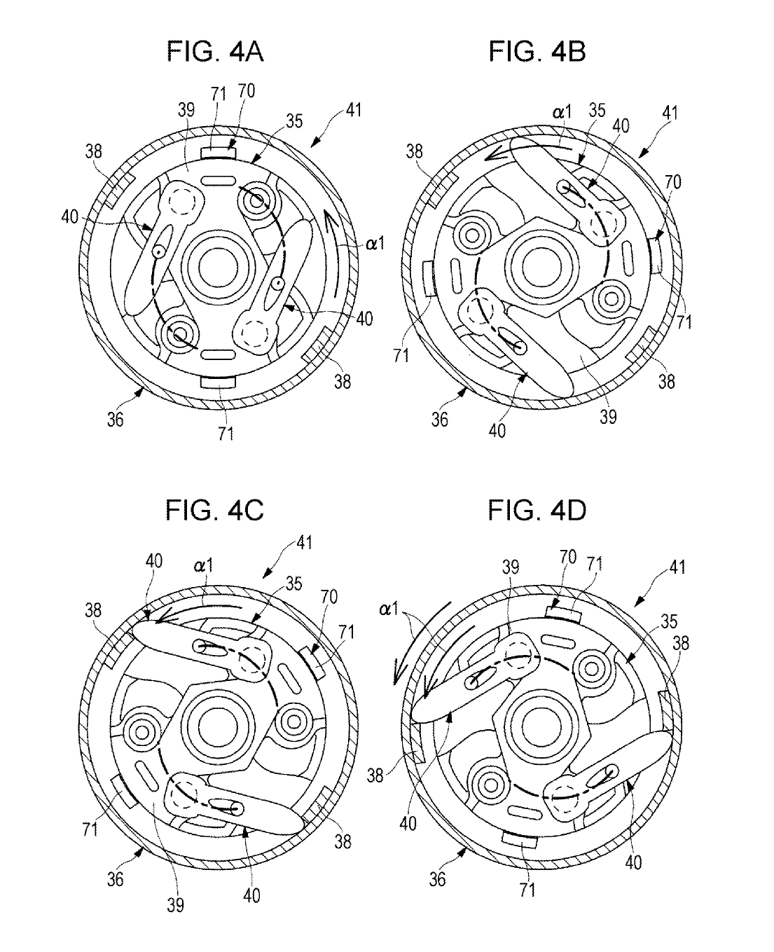

Here, FIGS. 4A to 4D are explanatory diagrams illustrating the operation process of the clutch mechanism 41 in the starting mode. As illustrated in FIGS. 4A and 4B, when the recoil rope 34 is pulled to rotate the reel 35 in the direction of arrow al with the lock member 70 placed at the release position, each ratchet pawl 40 swings towards the cup 36 outwardly in a radial direction according to a relative rotation between the reel 35 and the guide plate 64. When the ratchet pawl 40 comes into contact with the projection 38 of the cup 36 as illustrated in FIG. 4C, the reel 35 and the cup 36 are connected via the ratchet pawl 40 as illustrated in FIG. 4D, and thus both the reel 35 and the cup 36 rotate in the direction of arrow α1. In this manner, in the starting mode of the clutch mechanism 41, rotational force is transmitted from the reel 35 to the crank shaft 15 via the cup 36, thereby making it possible to cause the crank shaft 15 to start to rotate. It is to be noted that when the engine 10 is started and the crank shaft 15, that is, the cup 36 has an increased rotational speed, the cup 36 pushes down the ratchet pawls 40, passes through the reel 35 and rotates, and thus rotational force is not transmitted from the cup 36 to the reel 35. In this manner, the starting mode of the clutch mechanism 41 allows the clutch mechanism 41 to be operated as a unidirectional clutch, that is, allows transmission of force only in one direction from the reel 35 to the crank shaft 15.

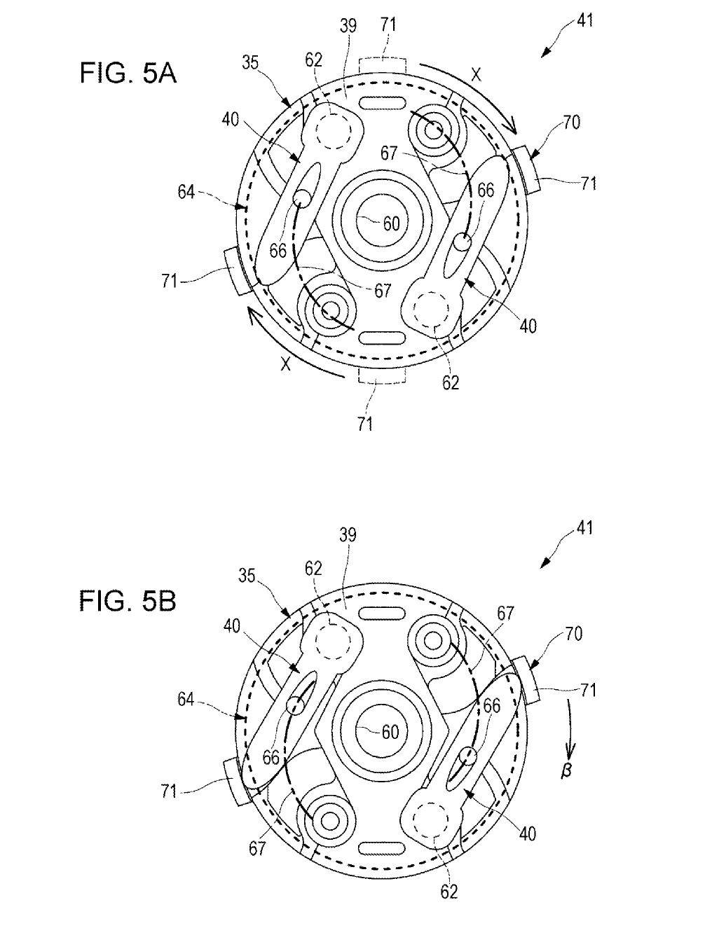

Next, the power generation mode of the clutch mechanism 41 will be described. FIGS. 5A and 5B are explanatory diagrams illustrating the operation of the ratchet pawls 40 in the power generation mode. When the clutch mechanism 41 is switched to the power generation mode, the lock member 70 is moved from the release position indicated by a dashed line to the regulation position indicated by a solid line as illustrated by arrow X in FIG. 5A. The regulation position of the lock member 70 faces the pointed end of a corresponding ratchet pawl 40 and causes interference between the lock member 70 and the ratchet pawl 40. In this manner, once the lock member 70 is placed at the regulation position, even when the guide plate 64 is rotated relative to the reel 35 in the direction of arrow β as illustrated in FIG. 5B, it is possible to regulate the swinging operation of the ratchet pawl 40 by a lock piece 71.

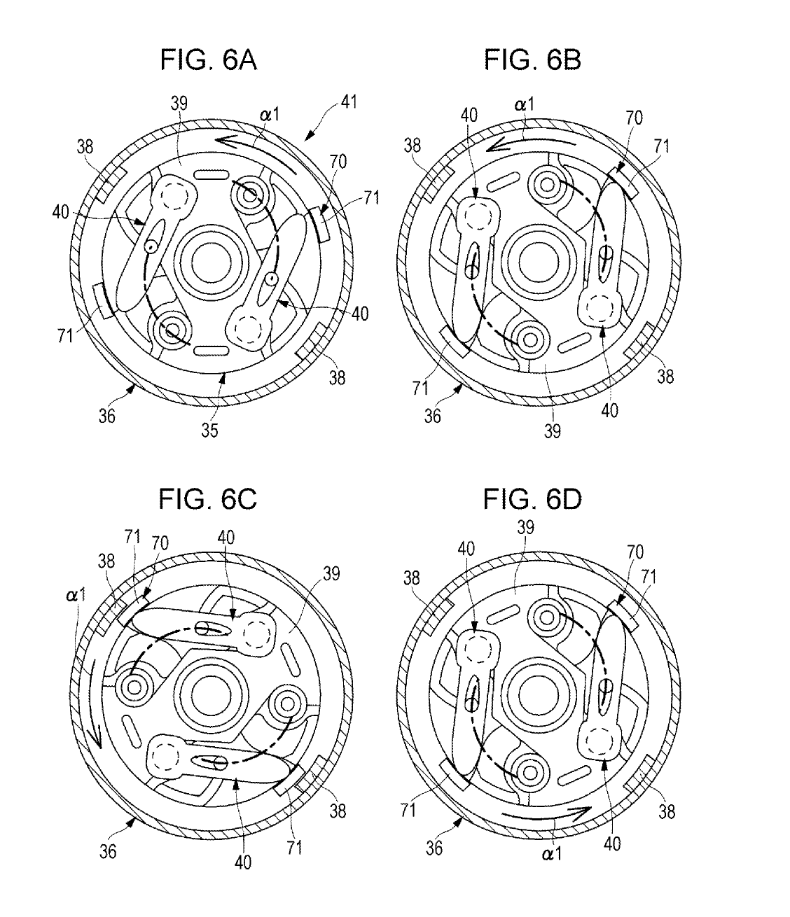

Here, FIGS. 6A to 6D are explanatory diagrams illustrating the operation process of the clutch mechanism 41 in the power generation mode. As illustrated in FIGS. 6A and 6B, when the recoil rope 34 is pulled to rotate the reel 35 in the direction of arrow al with the lock member 70 placed at the regulation position, the swinging operation of the ratchet pawl 40 is regulated by the lock member 70. That is, as illustrated in FIGS. 6C and 6D, the pointed end of the ratchet pawl 40 does not come into contact with the projection 38 of the cup 36 and the reel 35 rotates in the direction of arrow al with the cup 36 stopped. In this manner, the power generation mode of the clutch mechanism 41 allows the clutch mechanism 41 to be kept in a release state, that is, does not allow transmission of force in both directions between the reel 35 and the crank shaft 15. Because the reel 35 and the cup 36 are separated from each other in the power generation mode, it is possible to drive the sub-generator 51 for power generation without rotating the crank shaft 15 by operating the recoil starter 33.

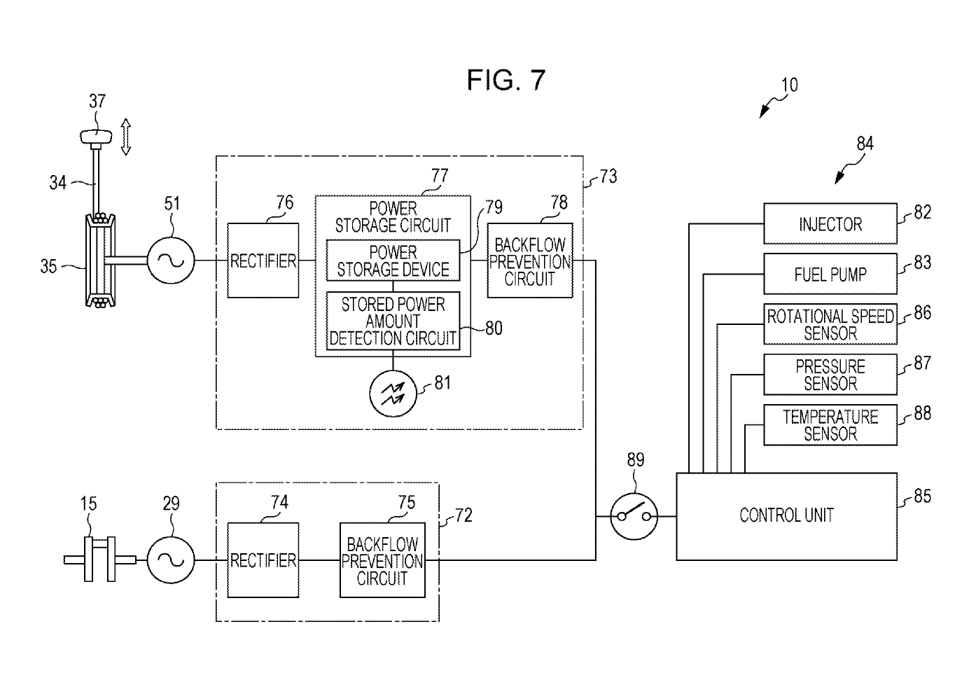

Next, the electrical system of the engine 10 will be described. FIG. 7 is a block diagram schematically illustrating part of the electrical system of the engine 10. As illustrated in FIG. 7, the engine 10 has two power generation systems 72 and 73. One power generation system 72 is provided with the main generator 29 and the other power generation system 73 is provided with the sub-generator 51. The power generation system 72 includes a rectifier 74 connected to the main generator 29 and a backflow prevention circuit 75 connected to the rectifier. The power generation system 73 includes a rectifier 76 connected to the sub-generator 51, a power storage circuit 77 connected to the rectifier, and a backflow prevention circuit 78 connected to the power storage circuit. The power storage circuit 77 includes a power storage device 79 including a capacitor, and a stored power amount detection circuit 80 that detects an amount of power stored in the power storage device 79. In addition, the power generation system 73 includes a lamp 81 that is turned on in the case where the amount of power stored in the power storage device 79 exceeds a predetermined value C1.

The engine 10 is provided with a fuel injection system 84 which includes an injector 82 and a fuel pump 83. The fuel injection system 84 is provided with a control unit 85 that outputs a control signal to the injector 82 and the fuel pump 83. The control unit 85 is connected to sensors such as a rotational speed sensor 86 that detects a rotational speed of the engine, a pressure sensor 87 that detects an intake pipe pressure, and a temperature sensor 88 that detects a temperature of engine oil. The control unit 85 sets a fuel injection timing and a fuel injection amount based on detection signals from the various sensors 86 to 88 and controls an operational state of the engine 10. It is to be noted that the control unit 85 includes a computer that calculates a signal such as a control signal, and a drive circuit that controls the driving current of the injector 82 and the fuel pump 83. Also, there is provided an electrical power switch 89 to be operated by manual operation or key operation between the power generation systems 72 and 73 and the fuel injection system 84.

In order to operate such fuel injection system 84, the fuel pump 83 and the injector 82 is preferably supplied with sufficient power, and so the main generator 29 having predetermined electrical generating capacity is mounted on the engine 10. However, the amount of electric power generation of the main generator 29 is in relation to a rotational speed of the engine, thus when the engine is started using the recoil starter 33, it has been difficult to supply sufficient power to components of the fuel injection system 84 like the fuel pump 83. Insufficient power at the time of engine start may reduce the performance of the fuel injection system 84 as well as the starting performance of the engine 10. Thus, the engine 10 according to an implementation of the present disclosure is preferably started by carrying out the starting process in accordance with the following procedure.

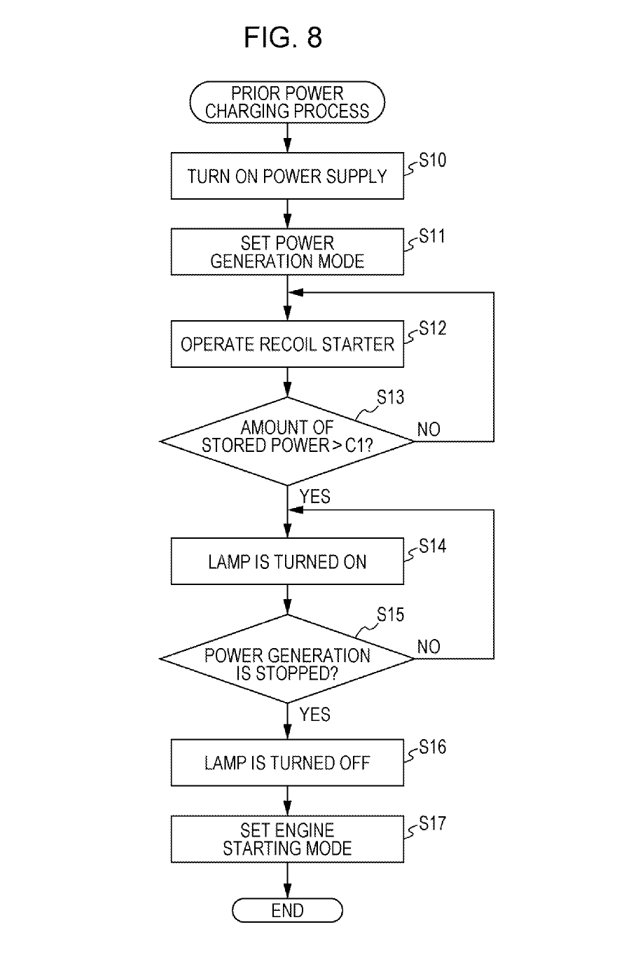

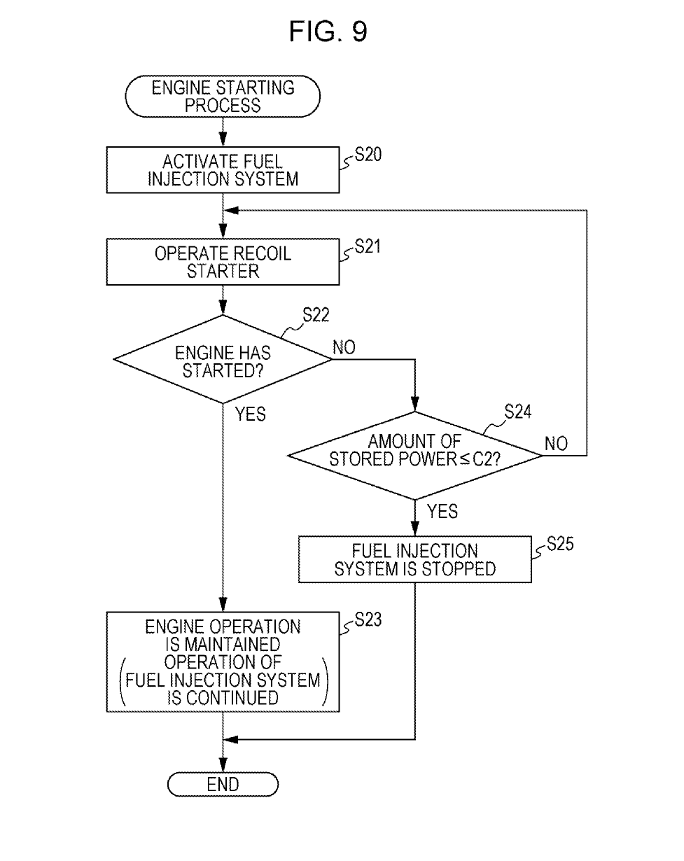

Hereinafter, the starting procedure of the engine 10 will be described. FIGS. 8 and 9 are each a flow chart illustrating an exemplary procedure for starting the engine. As illustrated in FIG. 8, in step S10, the electrical power switch 89 is turned on by an operator. In step S11, the lock member 70 is placed at the regulation position by the operator, and thus the clutch mechanism 41 is switched to the power generation mode. In subsequent step S12, the recoil starter 33 is operated by the operator and the sub-generator 51 is driven for power generation. At this point, the reel 35 is separated from the cup 36, that is, from the crank shaft 15, by the clutch mechanism 41 in the power generation mode, and thus it is possible to cause the sub-generator 51 to generate power with reduced effort of the operator. Furthermore, the sub-generator 51 is driven for power generation not only when the reel 35 is rotated by pulling out the recoil rope 34, but also when the reel 35 is rotated by the spring 61 in a direction in which the recoil rope 34 is wound. That is, the sub-generator 51 is driven for power generation in both rotation directions of the reel 35, thereby making it possible to cause the sub-generator 51 to generate power efficiently without wasting the effort of an operator.

Also, a recoil knob 37 grasped by an operator is composed of, for example, a rubber material, and the starter cover 32 for housing the reel 35 is composed of, for example, a plastic material harder than the rubber material. That is, the recoil knob 37 is formed to be softer than the starter cover 32. Consequently, even when the recoil knob 37 collides with the starter cover 32 while the recoil rope 34 is wound around the reel 35, it is possible to reduce damage to the starter cover 32 and the recoil knob 37. It is to be noted that the recoil knob 37 may be composed of a material other than rubber and the starter cover 32 may be composed of a material other than plastic. Also, all or part of the recoil knobs 37 may be covered with a rubber material.

Subsequently, in step S13, it is determined whether or not the amount of power stored in the power storage device 79 exceeds the predetermined value C1. When the amount of stored power exceeds the predetermined value C1, the flow proceeds to step S14 and the lamp 81 is turned on to inform an operator of completion of charging the power storage device 79. In step S15, when it is detected that power generation of the sub-generator 51 is stopped, that is, when it is detected that operation of the recoil starter 33 is stopped by the operator, the flow proceeds to step S16 and the lamp 81 is turned off. In step S17, the lock member 70 is placed at the release position by the operator and the clutch mechanism 41 is switched to the starting mode. In this manner, when the sub-generator 51 is driven for power generation by an operation of the recoil starter, lighting the lamp 81 informs the operator that the amount of stored power has exceeded the predetermined value C1, that is, power for operating the fuel injection system 84 has been reliably stored.

Subsequently, as illustrated in FIG. 9, in step S20, the fuel injection system 84 is activated using the power from the power storage device 79. In subsequent step S21, the recoil starter 33 is operated by the operator and the crank shaft 15 is caused to start to rotate by the clutch mechanism 41 in the starting mode. When it is determined in step S22 that the engine 10 has started, the flow proceeds to step S23, and the fuel injection system 84 is maintained by the power from the main generator 29 which is driven for power generation by the crank shaft 15, and the operational state of the engine 10 is maintained. On the other hand, when it is determined in step S22 that the engine 10 has not started, the flow proceeds to step S24 and it is determined whether or not the amount of power stored in the power storage device 79 is less than or equal to a predetermined value C2. When it is determined in step S24 that the amount of stored power exceeds the predetermined value C2, an activation state of the fuel injection system 84 is maintained, and the flow proceeds to step S21 and an operation of the recoil starter performed by the operator continues. On the other hand, when it is determined in step S24 that the amount of stored power is less than or equal to the predetermined value C2, the flow proceeds to step S25 and the fuel injection system 84 is stopped. When the fuel injection system 84 is stopped due to electric discharge of the power storage device 79, the power storage device 79 is charged by the sub-generator 51 according to the flow chart of FIG. 8 again.

Although the lamp 81 is turned off along with operation stop of the recoil starter as illustrated in step S16 of FIG. 8, without being limited to this, the lamp 81 may remain to be on. For example, as illustrated in step S25 of FIG. 9, the lamp 81 may remain to be on until the fuel injection system 84 is stopped. In this manner, the lamp 81 remains to be on until the fuel injection system 84 is stopped, thereby allowing the operator to clearly recognize that the fuel injection system 84 has stopped, and thus it is possible to urge the operator to drive the sub-generator 51 for power generation.

As described so far, power needed for the fuel injection system 84 may be reliably stored at the time of engine start by driving the sub-generator 51 for power generation using the recoil starter 33, and thus the starting performance of the engine 10 may be improved. In addition, when the sub-generator 51 is caused to generate power manually, the recoil starter 33 for starting the engine is used, and thus the complexity and cost of the engine 10 may be reduced. Also, the clutch mechanism 41 of the recoil starter 33 is made switchable between the starting mode and the power generation mode, and thus the recoil starter 33 and the crank shaft 15 may be separated from each other when the sub-generator 51 is caused to generate power by the recoil starter 33. In this manner, the sub-generator 51 may be driven for power generation without cranking the engine 10, and thus it is possible for an operator to perform a power generation operation easily. Also, the power transmission mechanism 50, which transmits rotational force to the sub-generator 51 from the reel 35, includes the driving pulley 52 and the driven pulley 53 having a smaller diameter than the driving pulley. Therefore, the rotational speed of the sub-generator 51 may be made higher than the rotational speed of the reel 35, and thus it is possible for an operator to perform a power generation operation easily.

The present disclosure is not limited to the above-described implementation, and needless to say, various modifications may be made without departing from the gist of the present disclosure. In the above description, the fuel injection system 84 is mounted on the engine 10. However, without being limited to this, the present disclosure may be applicable to an engine on which an electronic control system such as an electronic governor system or an electronic ignition system is mounted. In the above description, a battery such as a lead storage battery is not mounted in the engine 10. However, the present disclosure may be applicable to an engine in which a battery is mounted. In this manner, when the power of a battery is exhausted in the engine provided with the battery, the battery may be recharged by the sub-generator 51 which is manually driven for power generation, and thus the starting performance of the engine 10 may be improved.

In the above description, the clutch mechanism 41 of mesh type is used. However, without being limited to this, a clutch mechanism of friction type may be used. Also, the lock member 70 is manually rotated when the clutch mechanism 41 is switched between the starting mode and the power generation mode. However, without being limited to this, the lock member 70 may be rotated by an electric actuator or the like. It is to be noted that a booster transformer and a step-down transformer may also be incorporated in the power generation system 73 to which power is supplied from the sub-generator 51.

1. An engine having a crank shaft which is caused to start to rotate by pulling a recoil rope, the engine comprising:
a reel around which the recoil rope is wound;
a clutch mechanism which is provided between the reel and the crank shaft and switchable between a first state and a second state, the first state allowing transmission of force in one direction from the reel to the crank shaft, the second state not allowing transmission of force in both directions between the reel and the crank shaft; and
a power generator connected to the reel,
wherein when the crank shaft is caused to start to rotate, the clutch mechanism is switched to the first state, whereas when the power generator is driven for power generation, the clutch mechanism is switched to the second state.

2. The engine according to claim 1, further comprising a spring member that urges the reel in a direction in which the recoil rope is wound.

3. The engine according to claim 1, wherein
the reel and the power generator are connected to each other via a first rotating body provided in the reel and a second rotating body provided in the power generator; and
the first rotating body is greater than the second rotating body in a radial direction.

4. The engine according to claim 2, wherein
the reel and the power generator are connected to each other via a first rotating body provided in the reel and a second rotating body provided in the power generator; and
the first rotating body is greater than the second rotating body in a radial direction.

5. The engine according to claim 1, wherein a handle member provided at an end of the recoil rope is softer than a cover member which covers the reel.

6. The engine according to claim 2, wherein a handle member provided at an end of the recoil rope is softer than a cover member which covers the reel.

7. The engine according to claim 3, wherein a handle member provided at an end of the recoil rope is softer than a cover member which covers the reel.
